(19) United States
(12) Patent Application Publication
(10) Pub. No.: US 2018/0337385 A1
(43) Pub. Date: Nov. 22, 2018

(54) DIRECT CURRENT BATTERY STRING AGGREGATOR FOR STANDARD ENERGY STORAGE ENCLOSURE PLATFORM

(71) Applicant: Flex Ltd., Singapore (SG)

(72) Inventor: Alejandro Schnakofsky, Windermere, FL (US)

(21) Appl. No.: 15/872,071

(22) Filed: Jan. 16, 2018

Related U.S. Application Data
(60) Provisional application No. 62/507,388, filed on May 17, 2017.

(51) Int. Cl. H01M 2/20; H01M 2/10; H01M 2/34; H01M 10/42

(52) U.S. Cl. CPC H01M 2/206; H01M 2/1077; H01M 2220/10; H01M 10/4257; H01M 2010/4271; H01M 2/348

(57) ABSTRACT

The present disclosure is directed to a direct current aggregator including a plurality of battery strings having positive and negative terminals, a positive bus connected to a positive terminal of each of a plurality of battery strings and a negative bus connected to a negative terminal of each of a plurality battery strings. The direct current aggregator further including a switch associated with each positive terminal and each negative terminal of each of a plurality of battery strings, each switch capable of moving from a first open position to a second closed position, a fuse associated with each positive and negative terminal of each of a plurality of battery strings, and a controller in communication with each switch to place or remove one or more of the plurality of battery strings in electrical communication with the positive bus and the negative bus.

### BACKGROUND

### 1. Technical Field

The present disclosure is directed to a direct current battery string aggregator and related systems and components of a standardized energy storage enclosure platform. More specifically, the present disclosure is directed to a system for enhanced safety and monitoring for battery energy storage and discharge.

### 2. Related Art

There are known in the art standardized platforms (e.g., ISO compliant) for use as data centers. Many of these platforms are in fact shipping containers, which provide for a standardized form making handling, placement, and interconnection of the data centers quite simplified.

Similarly, others have proposed the use of a similar form factor (shipping containers) for use in connection with solar energy systems to assist in load sharing and energy storage. While these proposed systems work for their intended purposes, improvements are always desirable.

### SUMMARY

The present disclosure is directed to a direct current aggregator including a plurality of battery strings having a positive terminal and a negative terminal, a positive bus connected to a positive terminal of each of a plurality of battery strings, and a negative bus connected to a negative terminal of each of a plurality battery strings. The direct current aggregator includes a switch associated with each positive terminal and each negative terminal of each of a plurality of battery strings, each switch capable of moving from a first open position to a second closed position, a fuse associated with each positive terminal and each negative terminal of each of a plurality of battery strings, and a controller in communication with each switch and operable to cause each switch to move from the first to the second position to selectively place or remove one or more of the plurality of battery strings in electrical communication with the positive bus and the negative bus.

The direct current aggregator may further include a current transformer in electrical communication with the negative bus and in electrical communication with the switch associated with the negative terminal of each battery string. The current transformer may output a signal representative of the current flowing from the battery string to an input/output (IO) module. The IO module may receive an analog signal and outputs a digital signal to the controller. The batteries may be installed in racks.

The direct current aggregator may include a voltage transformer sensing the voltage across the positive and negative busses. The voltage transformer may output a signal representative of the voltage across the positive and negative busses to an IO module. The IO module may receive an analog signal and output a digital signal to the controller.

A further aspect of the present disclosure is directed to an energy storage platform including a container, a plurality of racks formed within the container and sized to receive a plurality of batteries and form a plurality of battery strings, and a direct current aggregator. The direct current aggregator includes a plurality of first fuses connectable to at least one of the batteries strings, a plurality of second fuses connectable to at least one of the batteries strings, a set of first switches associated with each of the plurality of first fuses and capable of moving from a first open position to a second closed position, and a set of second switches associated with each of the plurality of second fuses and capable of moving from a first open position to a second closed position. The direct current aggregator further includes a positive bus electrically connected to each first switch and a negative bus electrically connected to each second switch. Still further the direct current aggregator includes a controller in communication with each first and second switch and operable to cause each first and second switch to move from the first position to the second position to selectively place or remove one or more of the plurality of battery strings in electrical communication with the positive bus and the negative bus.

The energy storage platform may further include a plurality of batteries inserted into each of the plurality of racks and forming a plurality of battery strings. Each battery string may be electrically connected to at least one first fuse and at least one second fuse. Each battery string may be electrically connected to at least one first switch and at least one second switch. And each battery string may be isolated from the positive and negative busses by moving the at least one first switch and the at least one second switch electrically connected thereto from the second position to the first position.

The energy storage platform may further include at least one inverter. The energy storage platform may also include at least one internet connection for transmitting and receiving data from an energy management system. The controller may receive data from one or more of a remote temperature detector, airflow sensors, door sensors, voltage sensors, current sensors, power meters, fire suppression systems, or heating ventilation and air conditioning systems.

Further, to the extent consistent, any of the aspects described herein may be used in conjunction with any or all of the other aspects described herein.

### BRIEF DESCRIPTION OF THE FIGURES

Objects and features of the presently disclosed system and method will become apparent to those of ordinary skill in the art when descriptions of various embodiments thereof are read with reference to the accompanying drawings, of which:

FIG. 1A is a partial schematic view of a Direct Current Aggregator (DCA) in accordance with the present disclosure;

FIG. 1B is a partial schematic view of a Direct Current Aggregator (DCA) in accordance with the present disclosure;

FIG. 2 provides three views of the DCA shown schematically in FIG. 1;

FIG. 3 depicts control aspects of the DCA of FIG. 2;

FIG. 4 depicts a side view of a Standard Energy Storage Enclosure Platform (SESEP) in accordance with the present disclosure;

FIG. 5 depicts a top profile view of the SESEP of FIG. 4;

FIG. 6 depicts another profile view of the SESEP of FIG. 4 with the side doors removed;

FIG. 7 depicts another profile view of the SESEP of FIG. 4 with the side doors removed;

FIG. 8 depicts an end view of the SESEP of FIG. 4 outlining the hot and cold aisles;

FIG. 9 is a schematic view of a control system of the SESEP of FIG. 4;

FIG. 10 depicts another schematic view of a control system of the SESEP of FIG. 4;

FIG. 11 depicts yet another schematic view of a control system of the SESEP of FIG. 4.

### DETAILED DESCRIPTION

In accordance with one aspect of the present disclosure, a direct current aggregator (DCA) capable of aggregating the energy delivery from a number of battery strings is provided. The DCA is a device that parallels and aggregates battery strings in order to achieve a desired power and current rating for a battery powered energy system to interface with a power conversion system. The DCA works in both floating and non-floating configurations by creating a positive (+) and a negative (−) bus where the respective battery string conductors are aggregated. The DCA also provides short circuit protection and disconnecting means per battery string. DC power monitoring, surge suppression, and ground fault detection are also features of the DCA.

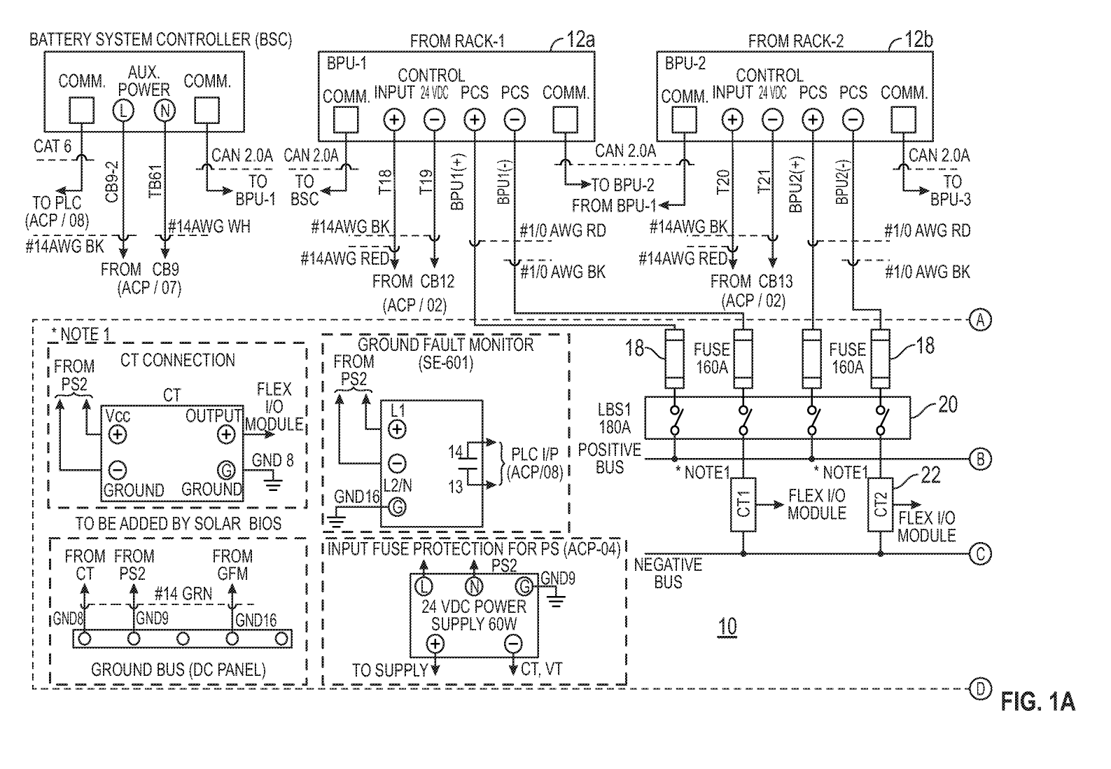

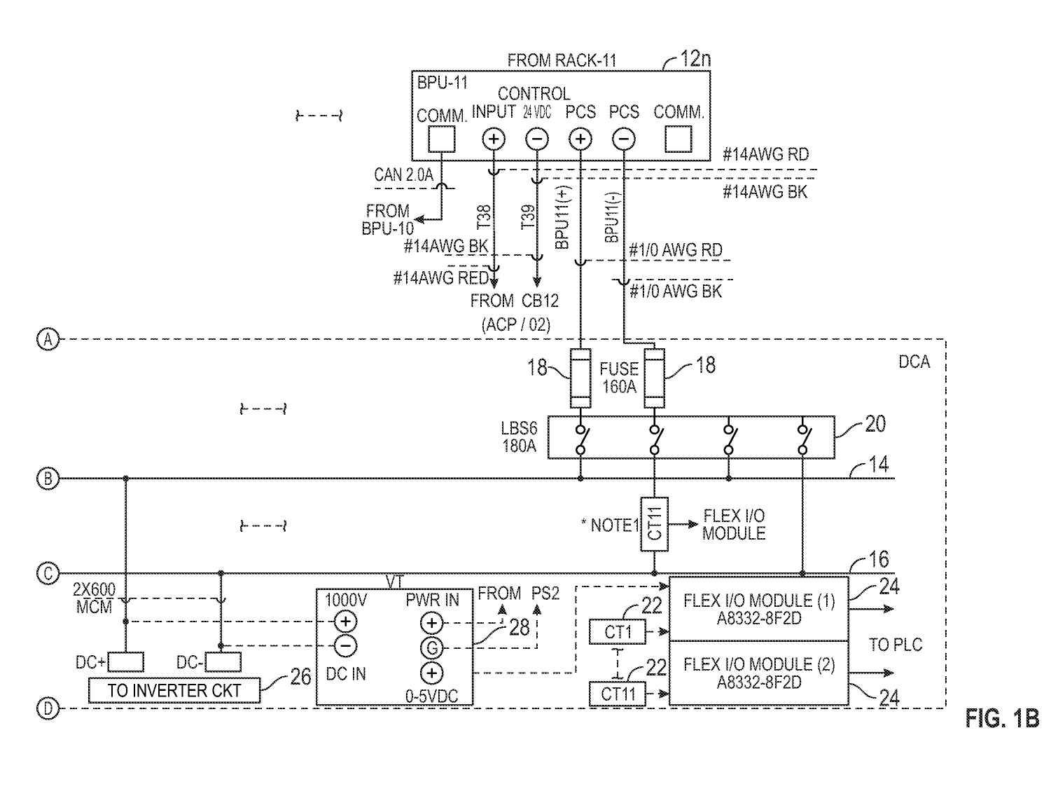

FIG. 1 depicts a schematic of the DCA 10 including a number of battery strings 12a-n, where “n” is a variable number. Each battery string 12a-n may be formed of a plurality (e.g., 10-25) of individual batteries (not shown) connected in series and mounted in a rack. Each battery string 12a-n is electrically connected to both the positive bus 14 and the negative bus 16 through fuses 18 and configurable switching. In line with each battery string 12a-n is a current transformer (CT) 22 which allows for monitoring of the load applied to each battery string 12a-n and/or applied to each battery in the battery string 12a-n individually. The signal generated by each CT 22 is output to an input/output (IO) module 24. As depicted in FIG. 1, the IO modules 24 are connected to a programmable logic controller (not shown) which controls switches 20 and provides data regarding the status of the DCA to control systems. The input of the IO modules 24 may be an analog signal (e.g., 0-5 VDC) and the output of the IO modules 24 may be a digital signal.

The buses 14 and 16 in FIG. 1 are depicted as discharge buses as each is connected to an inverter 26, which converts the DC power available on the busses 14, 16 to AC power for feeding into an AC power grid (not shown). A voltage transformer 28 measures the voltage across the busses 14 and 16 and reports this information to the IO modules 24. Busses 14 and 16 may also operate as charge busses, which receive electrical energy from nearly any source of DC electrical energy to charge the batteries in the battery strings 12a-n. Alternatively, separate charge busses may be employed and, in accordance with one embodiment of the present disclosure, may receive the DC electrical energy from one or more solar arrays, for example solar tracking arrays which are capable of tracking the sun from sunrise to sunset.

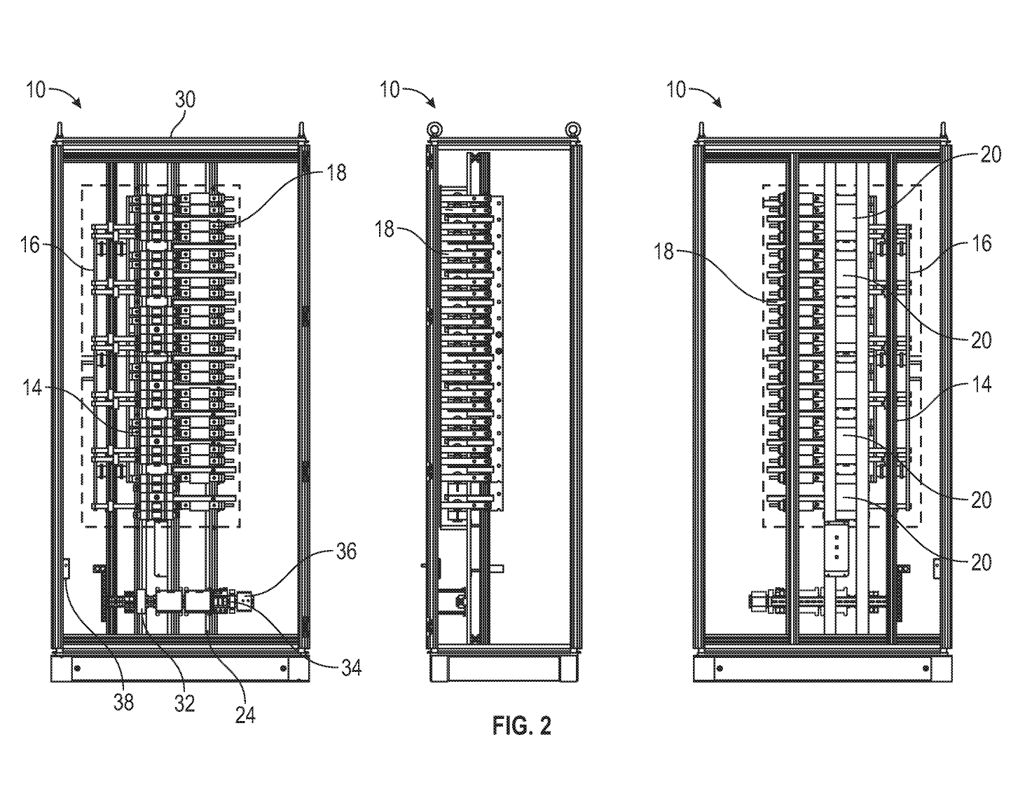

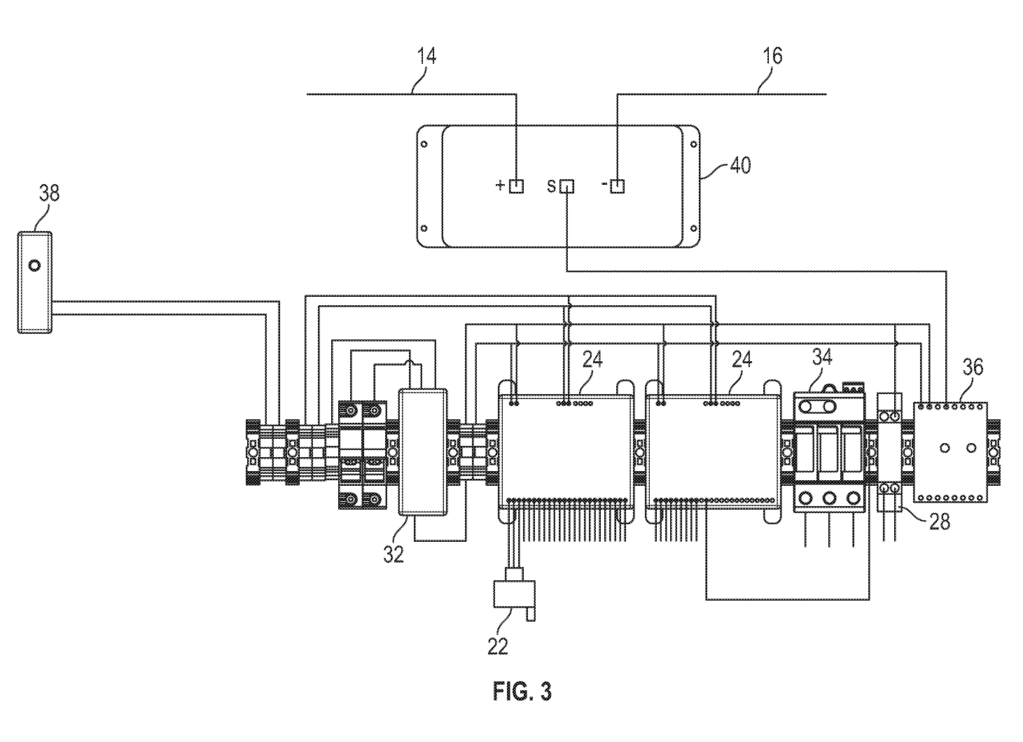

FIG. 2 depicts a cabinet 30 in accordance with the schematic of FIG. 1 housing the DCA. The cabinet houses fuses 18 which connect to the cables (not shown) from the battery strings 12a-n to the switches 20 and ultimately the positive bus 14 and negative bus 16. On a DIN rail near the bottom (see FIG. 3) are housed a variety of lower voltage components including a power supply with related fuse protections 32, IO modules 24 for monitoring the current and voltage output from each of the battery strings 12a-n, a surge protector 34, and a ground fault interrupter (GFI) 36. Also shown in FIG. 2 is a door indication switch 38 which provides a signal to the IO modules 24. Another fuse 40 (FIG. 3) separates the GFI from the bus bars.

As noted above, the DCA 10 is a device that parallels and aggregates battery strings 12a-n in order to achieve a desired power and current rating for the system to interface with a power conversion system (e.g., inverter 26) and ultimately the power grid. The DCA works in both floating and non-floating configurations by creating a positive (+) bus 14 and a negative (−) bus 16 where the respective battery strings 12a-n are aggregated. The DCA also provides short circuit protection in the form of fuses 18 on both the positive (+) bus 14 and the negative (−) bus 16 connections. Further, switches 20 enable connection or disconnection of the battery strings 12a-n from both the positive (+) bus 14 and the negative (−) bus 16. Further, DC power monitoring is provided in the form of the current transformers 22, and voltage transformer 28, both of which provide information to the I/O modules 24. Still further, surge suppression components 34, and ground fault detectors 36 provide additional safety functionality of the DCA.

One benefit of the DCA 10 is the added short circuit protection afforded by the design. By fusing each battery string 12a-n on the positive (+) bus 14 and negative (−) bus 16 separately, and by providing individualized switches 20 for each connection to the busses 14 and 16, the overall short circuit protection is increased. As an example, if each battery string or rack requires 10,000 Amps of short circuit protection, in a system employing 10 battery strings, one would require a 100K amp of short circuit protection. By having individualized fuses 18 and switches 20, the DCA 10 is able to reduce the individual battery string short circuit protection requirement to a more manageable and safer level of protection. The reduction in short circuit current is possible by carefully selecting fuse types and sizes that ultimately reduce the peak let through current of each rack or group of racks being aggregated. The selection of the fuse type and size to achieve such result is made possible by conducting a real time digital simulation of the system whereby impedances are accurately represented and fault conditions modeled in order to validate the reduction in peak let through current which ultimately reduces the short circuit current of the overall arrangement.

Though generally described herein as being associated with containerized battery strings 12a-n the systems and methods described herein are not so limited. For example, the DCA 10 may be employed as part of a warehouse-style battery bank without departing from the scope of the present disclosure. In such an instance, each string of 10-25 batteries is connected to the DCA 10 and any number of battery strings (e.g., 12a-n) may be connected to a single DCA 10. For purposes of manufacturing and ease of deployment, in accordance with one embodiment up to 50 battery strings may be aggregated in a single DCA 10. The DCA may have a form factor capable of fitting through a standard 36 inch door, however, other form factors may be envisioned without departing from the scope of the present disclosure.

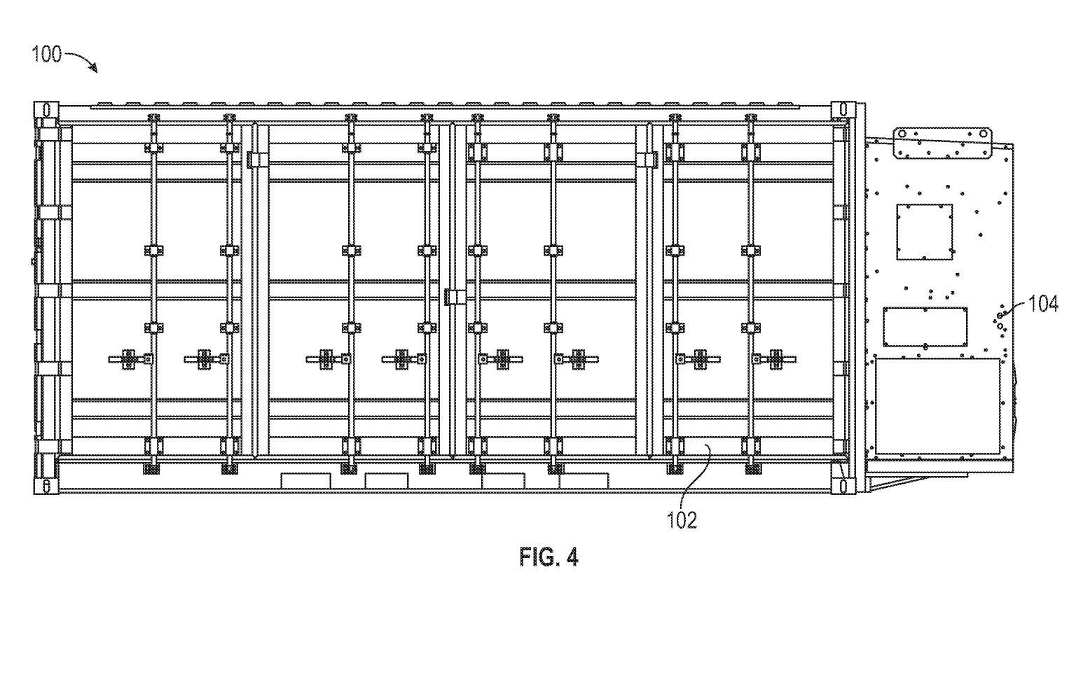

The DCA 10 provides standardized aggregation of DC power that allows for implementation in a wide variety of load applications. As described above, in the context of a standardized shipping container application, also referred to as a Standard Energy Storage Enclosure Platform (SESEP), the DCA 10 allows for racks to be filled with sufficient batteries to form the battery string 12a-n. FIGS. 4-7 depict various views of an exemplary SESEP.

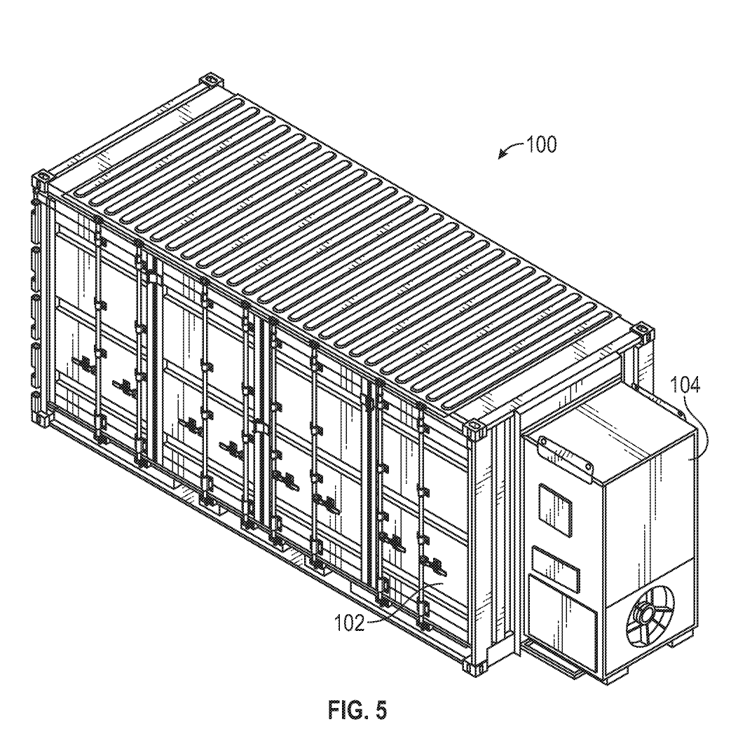

FIG. 4 depicts a side view of an SESEP 100 including a number of doors 102, and an HVAC system 104 mounted on a side thereof. As will be described in greater detail below, each of the doors 102 may be opened providing access to the battery strings 12a-n and the DCA 10. FIG. 5 provides a top profile view of the SESEP 100. As can be seen the SESEP is formed of a standard shipping container (e.g., 20, 40, 45 foot container).

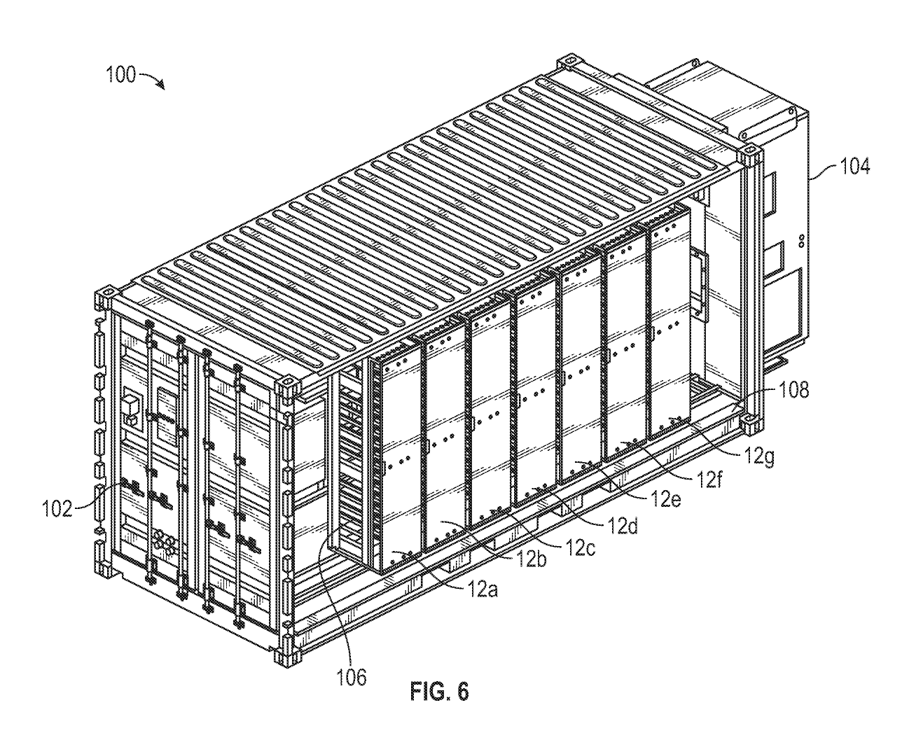

FIG. 6 depicts a side perspective view of the SESEP 100 having the doors 102 removed from one side. Racks 106 including battery strings 12a-n are shown and, as can be readily comprehended by one of skill in the art, are easily accessible upon removal or opening of doors 102 on the side of the SESEP 100. Though not clearly shown in FIG. 6, the space between the doors 102 (removed) and the racks 106 housing the battery strings 12a-n form a hot aisle 108 which is in fluid communication with an air inlet side of the air HVAC system 104.

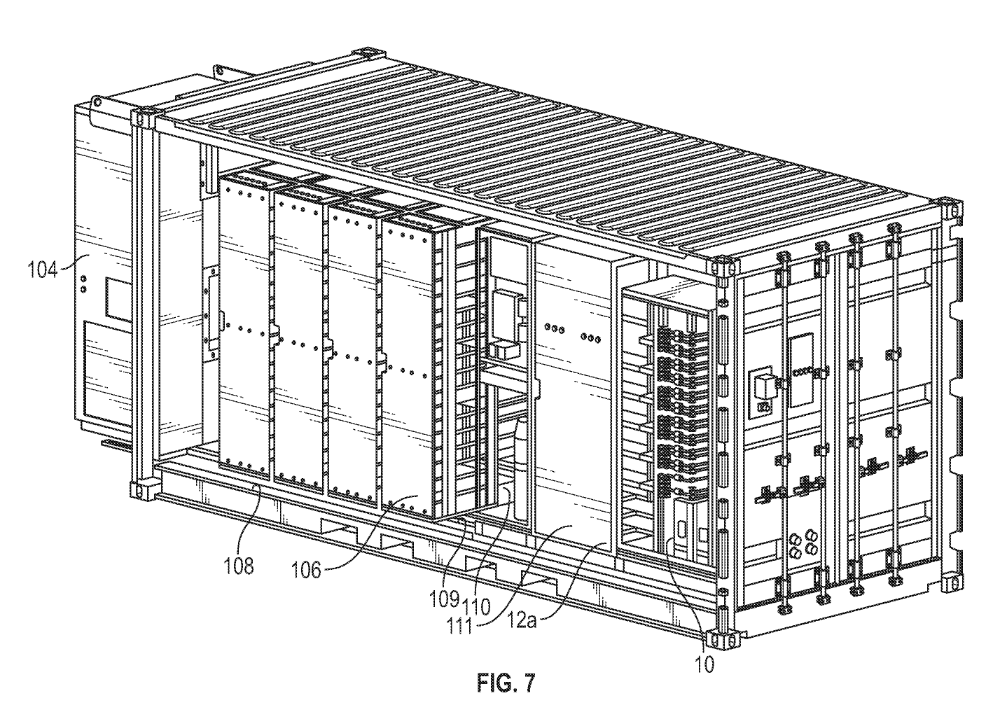

FIG. 7 depicts the opposite side perspective view of the SESEP 100 of FIG. 6. Again the doors 102 on the side of the SESEP 100 have been removed to expose the racks 102 housing battery strings 12a-n. Also depicted is the DCA 10. Again, the hot aisle is formed between the doors 102 and the racks 102. Also shown in FIG. 7, is a space 109 where a rack 106 has not been installed, or has been removed. The removal of the rack 106 from space 109 exposes a cold aisle 110. As can be readily understood, the cold aisle 110 is typically pressurized by air output of the HVAC system 104. This cold air is allowed to flow across the racks 102 to cool the battery strings 12a-12n and maintain the proper operating conditions for the batteries and the electronics of the DCA 10.

The number of racks 106 may be installed in the SESEP 100 to meet a specific application. For example, in a standard 20 foot container, up to about 11 racks or strings may be installed. However, for a certain application it may be determined that only 6 strings of batteries are needed. The DCA 10 allows for the construction of a need specific SESEP 100 of just 6 strings to be deployed, without changing the architecture of the SESEP 100 and with minimal unused wiring being deployed. If additional demand builds at a particular site, additional battery strings 12a-n and racks 106 may be added to the SESEP 100 to meet the demand, and the DCA 10 is able to accommodate these with little to no additional on-site electrical work being undertaken. Following installation of the additional battery strings 12a-n, the switches 18 associated with those battery strings 12a-n may be closed and the energy of the batteries is available on the buses 14 and 16. All this is possible without alteration of the DCA 10 of the SESEP 100 except the addition of additional batteries to fill the racks 106.

As can be appreciated, the SESEP 100 enclosure provides an environment for the batteries where a thermal management system (e.g., HVAC system 104), a fire suppression system and auxiliary power distribution systems (which can be housed in rack 111), battery aggregation and protection (e.g., DCA 10), as well as a control and monitoring system (which may also be housed in rack 111) are included. Such systems are pre-engineered and configurable based on the system requirements. The enclosure may be designed to comply with ISO 668 in order to facilitate logistics worldwide.

Additionally, by installing the racks 106, on which the batteries that make up each battery string 12a-n are to sit, with the initial construction of the SESP 100, all that is required to be brought to the site are the batteries themselves. It is customary in the related field of data centers to perform the installation of both the racks and the servers and switching components on site. As can be appreciated, it would be undesirable to ship these relatively sensitive and highly costly components in the container itself from the integrator or manufacturer of the data center to its ultimate destination and subject them to the stress of transportation within the container. Indeed, in many instances the heating ventilation and air conditioning systems are inoperable during transportation. The result is a time consuming and often challenging task of remote installation of racks and electronics on site. A further aspect of the present disclosure is the pre-installation of the racks 106, on which the strings of batteries 12a-n will rest, at the manufacturer or integrator's location. This installation may be complete with necessary wiring to connect each battery in series to form the strings and to connect the battery strings 12a-n to the buses 14 and 16 via the DCA 10 or with just the cabling to connect a battery string 12a-n to the DCA 10 in place. In the later instance, the individual connections of the batteries can be installed with the batteries themselves. In this manner, final configuration of an SESEP 100 can be undertaken in the field with little to no involvement of the integrator/manufacturer of the SESEP 100 itself. Each SESEP 100 comes ready to be loaded with up to its maximum number of battery strings 12a-n. The battery supplier can be tasked with delivery of a specified number of batteries to meet the current demand and only those battery strings 12a-n necessary will be installed and their respective switches 18 on the DCA 10 permitted to close to permit flow of energy from the battery strings 12a-n and the busses 14, 16. As a result, in the instance described above where additional load necessitates additional batteries be installed, these may be procured consistent with the need, after procurement of the additional batteries, these are easily installed on the racks 106 and connected to the DCA 10 and ready for their integration with minimal downtime for the SESEP 100 while the installation is being performed.

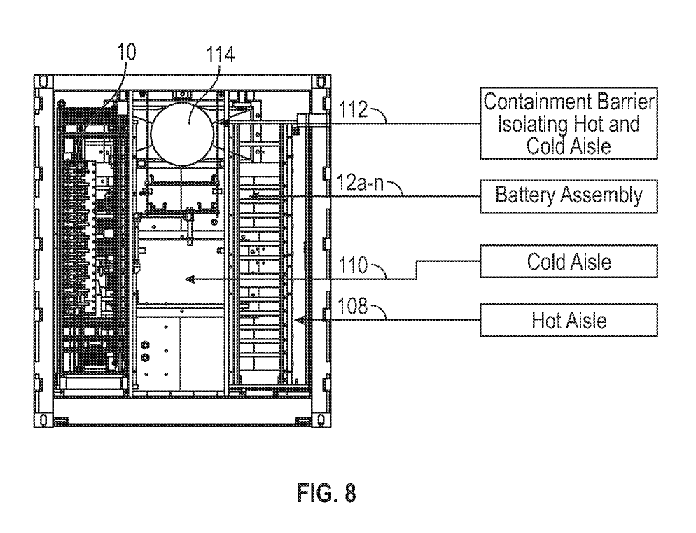

FIG. 8 depicts an end view of the SESEP 100 with doors 102 on the end removed to expose the hot aisle 108 and cold aisle 110 configuration of the SESEP 100 in accordance with the present disclosure. The HVAC system 104 connects to the outside of the SESEP 100 and ducting extends the length of the SESEP 100. The internal side of the racks 106 and other equipment including the DCA 10, fire suppression, power distribution, lights and the master controller (all of which are installed on racks or rack-like components 111), have a containment barrier 112 formed of a substantially solid sheet metal surface facing the cold aisle. This containment barrier 112 has holes drilled into it of various sizes. These sizes increase in diameter from small to large in a gradient from smallest at the top near an outlet 114 of the HVAC system 104 to largest at the bottom on the end of the SESEP 100 opposite the HVAC system 104. In this way the thermal requirements for cooling the battery strings 12a-n can be met without undue sub-cooling and at the same time ensuring that sufficient cooling reaches all areas of the SESEP 100. The gradient of size based on proximity to the outlet 114 of the HVAC system 104 ensures that relatively small volumes of the coldest air pass over batteries closest to the HVAC system 104 and in contrast, where the air might be slightly warmer, larger volumes of cooling air are used to meet the thermal demands of batteries and electronics in those locations (e.g., furthest from the outlet 114). In general, the cold aisle 110 is pressurized above atmospheric to ensure that airflow is always from the cold aisle 110 to the hot aisle 108.

In an alternative embodiment, the cold aisle 110 facing sides of the battery strings 12a-n are equipped with motor controlled registers (not shown) which can be opened and closed as needed for each individual battery within the SESEP 100. In one scenario, where the SESEP 100 is sitting on a cold surface, but the sun is warming the upper regions of the SESEP 100, the registers may be employed to open for the upper portions of the batteries strings 12a-n, and remain closed for the lower portions of the battery strings 12a-n while they are still being conductively cooled by the ground outside the SESEP 100. As the temperature within the SESEP 100 rises, additional registers can open to increase the amount of cool airflow in those regions. In addition to opening the registers to allow more airflow, the output of the HVAC system 104 may increase providing more cooling output from the HVAC unit. The combination of more and colder airflow over the batteries and electronics can be managed to maintain a desired operating environment. Ultimately the configuration may result in a similar scenario to that described above, with the registers at the bottom and furthest away from the outlet 114 of the HVAC system 104 being the most open and allowing the greatest volume of air to flow, while those closer to the outlet 114 of the HVAC system 104 actually reducing their airflow as the cooling output from the HVAC system 104 increases.

The hot aisle 108 is formed between the racks 106 and the sidewalls (in some instances formed by doors 102) of the SESEP 100. The doors 102 can be opened to provide access to the battery strings 12a-n and other components of the SESEP 100, as shown in FIGS. 4-7. The hot aisle 108 is in fluid communication with evaporator side of the HVAC system 104 providing for closed loop airflow within the SESEP 100. As will be appreciated, a separate flow of air is used to cool the refrigerant in the HVAC system 104 after compression to form the condensate to be evaporated in the evaporator and cool the air being blown into the cold aisle. In addition to creating the hot aisle, the doors 102 which open on the sides of the SESEP 100 allow for maintenance of the systems without requiring entry into the SESEP 100 and thus promote efficiency and safety.

The HVAC unit 104 may be a variable speed unit capable of matching the speed of the compressor to the cooling demands of the SESEP 100. This may be particularly important in instances where the SESEP 100 is not configured with a full complement of battery strings 12a-n. As will be appreciated, in such instances the thermal load of the HVAC system 104 will be reduced. Utilizing a variable speed unit allows for greater uniformity of temperature within the SESEP 100 and reduces the cycling of the HVAC system 104.

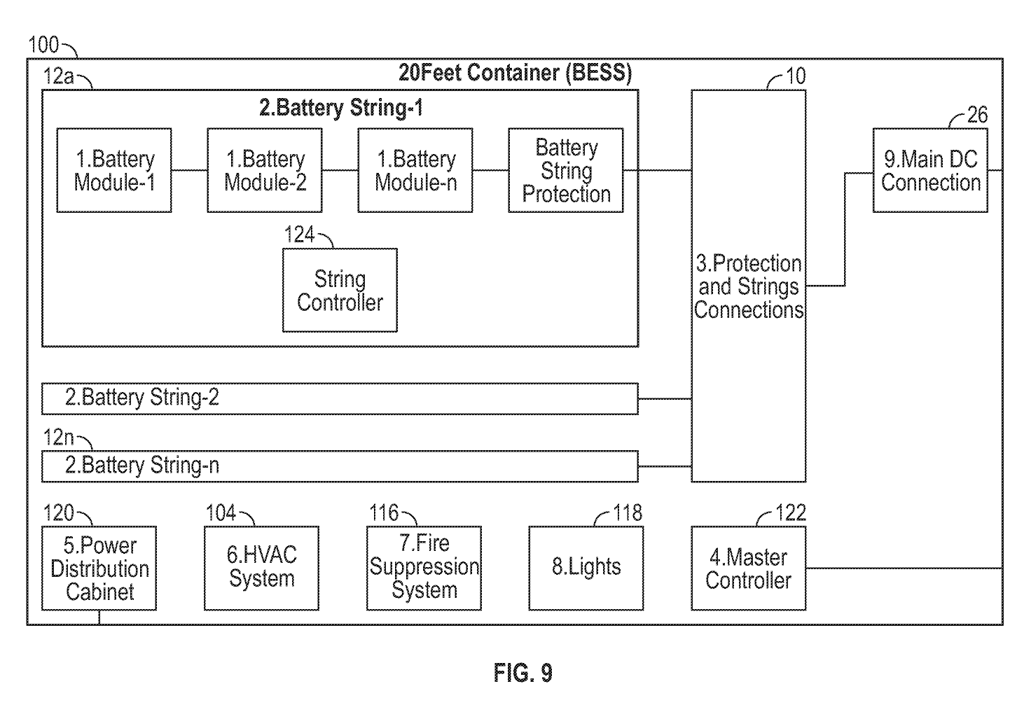

FIG. 9 provides a schematic view of the components of the SESEP 100. As noted above, a number of strings of batteries 12a-n are provided, and housed in racks 106. These connect to the DCA 10 to provide circuit protection and aggregation functions, as described above, as well as configurability of the SESEP 100. Also included within the container are the HVAC system 104, fire suppression systems 116, lighting systems 118, power distribution systems 120, and a master controller 122. Each of these may be housed in one or more racks 106 such that they are essentially modular components that can be interchanged and serviced easily. The master controller 122 may be a programmable logic controller (PLC). Also depicted in FIG. 9 is a string controller 124, that can monitor the individual batteries within a battery string 12a-n, control charging, collect data regarding state of health of individual batteries, state of charge, temperature, etc. and report this data to the master controller 122.

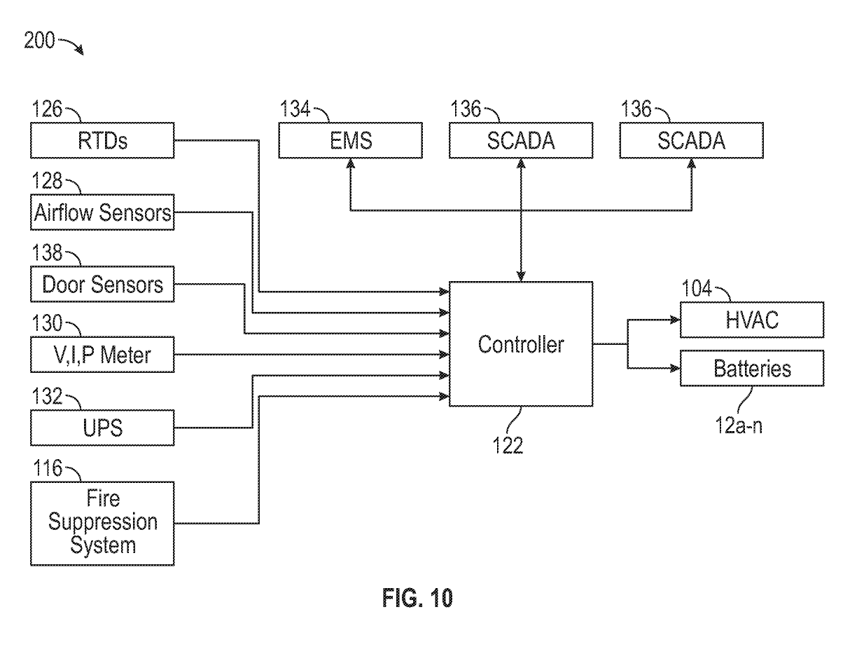

FIG. 10 depicts a schematic of a control system 200 for the SESEP. As depicted, both the battery strings 12a-n and the HVAC system 104 are in communication with the controller 122. The controller also receives inputs from a variety of environmental sensors including temperature sensors such as resistance temperature detectors (RTD's) 126, airflow sensors 128 to ensure airflow throughout the SESEP 100, door sensors 38 to limit or prevent power output with the doors are open, uninterruptible power supplies 132, fire suppression systems 116, and power output sensors 130 to measure parameters such as voltage, current, and power being delivered from the SESEP 100, or available for distribution from within the battery strings 12a-n. The controller 122 also communicates via an energy management system (EMS) to utilities and facilities that are drawing power from the SESEP 100. Further, operator communications can be presented to engineers and service personnel through various supervisory control and data acquisition (SCADA) interfaces 136. SCADA control system architecture employs computers, networked data communications and graphical user interfaces for high-level process supervisory management. The operator interfaces which enable monitoring and the issuing of process commands, such as controller set point changes, are handled through a SCADA supervisory computer system (not shown).

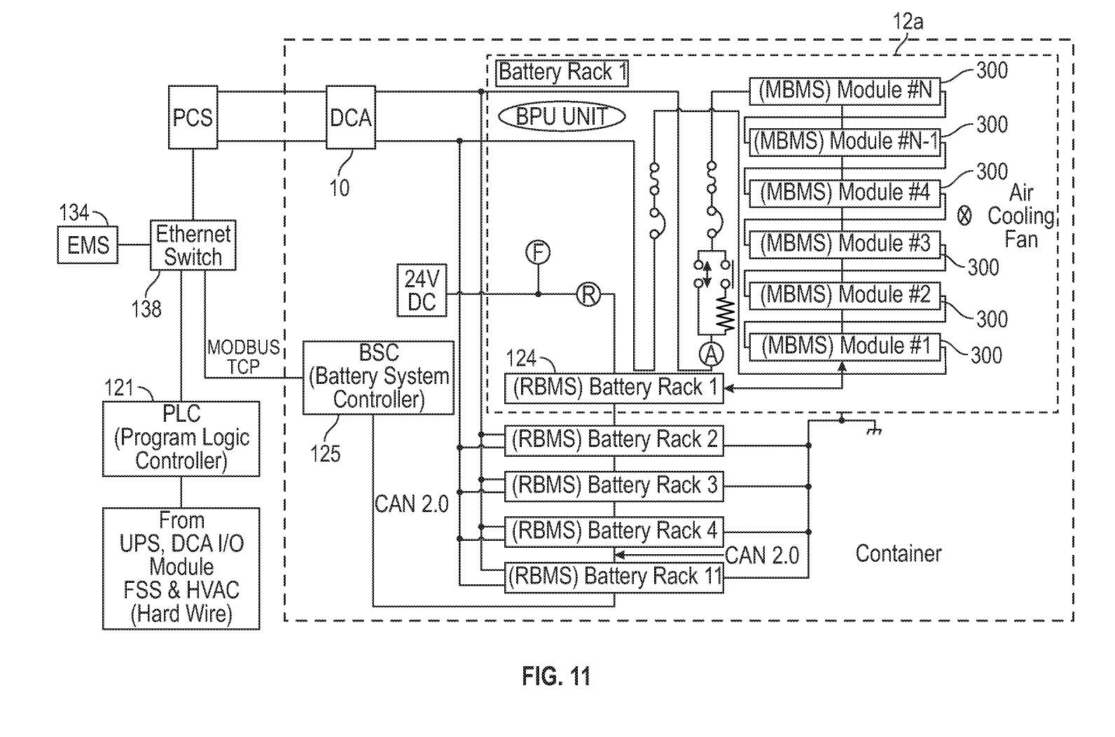

FIG. 11 depicts a further schematic of the SESEP 100 in accordance with the present disclosure. As depicted, each battery in the rack 12a (for example) includes a main battery management system (MBMS) 300 (e.g., a microcontroller) in electrical communication with the batteries and which reports on battery health, state of charge, capacity, and other common parameters. This data is shared with RBMS (or string controller) 124, which in turn reports the data to the BSC (Battery System Controller). Both the RBMS 124 and BSC 125 may be PLCs. The data received by the BSC 125 can be transmitted to the EMS 134, and data can be received from the EMS 134 via a connection to the internet via, for example, an Ethernet switch 138 or a Wi-Fi connection. In addition, data can be received from other peripheral components of the SESEP 100 (e.g., UPS, HVAC, DCA, fire suppression, etc.) and reported to the EMS 134 via a peripheral controller 121. In this embodiment, the master controller of FIG. 10 is bifurcated into the BSC 125 and the peripheral controller 121, though one of skill in the art will recognize that these functions may be embodied on a single controller or other arrangements of controllers without departing from the scope of the present disclosure.

The MBMS 300, RBMS 124, and BSC 125 perform necessary functions to ensure the proper utilization of the batteries. It is important that functions be monitored in real time in order to detect any abnormalities. The BSC 125 aggregates all sensor data received the RBMSs relating to the batteries contained within the SESEP 100, logs any changes of status, takes corrective action when necessary, and presents all of this information to the EMS 134 and SCADA systems 136.

By receiving data, including load and expected load and other data such as time of sunrise/sunset and expected hourly temperatures from the EMS 134, and correlating it with actual temperatures within the SESEP from the RTDs 125 and battery health information from the MBMSs 300, a thermal management system profile can be devised for the SESEP 100. This profile may be maintained in the master controller 122 and relied upon to control various aspects of the SESEP 100 (e.g., HVAC system 104 or DCA 10). A thermal management system profile for lithium-ion based battery energy storage systems is important as it is responsible for maintaining adequate temperature inside the enclosure ensuring the safe operation as well as mitigating degradation of the batteries as a result of overheating. The thermal management profile controls the operation of the HVAC system 100 so the environment is properly cooled in anticipation of an increase in temperature due to the battery cycling action which generates significant amounts of heat. The system may use current flow and load information to proactively cool the environment and ensure the proper functioning of the batteries in anticipation of heating within the SESEP 100.

A further aspect of the present disclosure is directed to a method of designing a thermal management system of a particular SESEP 100. The methods described herein ensure the proper and optimal sizing of the system by considering a wide range of variables. The process can be broken down into 3 stages; data collection and analysis, system selection, and validation.

As part of the data collection and analysis stage, a use case needs to be defined for the batteries. This use case needs to include features such as life cycle, number of cycles per day, depth of cycles, c-rates, and any potential deviations from these parameters. As is well known, during both charge and discharge batteries give off heat as a byproduct of the chemical reactions taking place within the batteries. This heat dissipates to any enclosure in which the batteries are located and cause the temperature to rise. The heat dissipation values per battery assembly, which can be acquired from the battery manufacturer, need to be incorporated into the use case to define the amount of heat the batteries will generate on a given day or at least over a cycle of the batteries. Further, heat dissipation values of other devices (e.g., control systems, electronics, the DCA 10, inverter 26, and others) as a result of the use case need to be calculated and included in a total heat generation value.

Next, information regarding the insulative capabilities of the enclosure needs to be accounted for. The insulative capabilities of the enclosure in conjunction with the dimensions define how much of the heat generated within the enclosure may be radiated to the environment as well as how much heating or cooling may be experienced within the enclosure as a result of the sun or ambient conditions.

With the internal heat generation values of the batteries and other components that are located within the container calculated, next a load calculation utilizing the RTS method is undertaken. The RTS method takes into account not just the heat generation capabilities and insulative properties of the enclosure but also the geographical location of the SESEP 100 and the site conditions into consideration. As will be appreciated, days of sunshine, maximum, minimum, and average temperatures, prevailing wind direction and strength, as well as other factors can have an effect on the total load an HVAC system 104 will be required to meet.

Once the load is established, an HVAC system 104 may be selected based on load calculations. That is, identifying and selecting an HVAC system that can accommodate the peak loads with some safety margin, and yet prove efficient in most or a majority of operating conditions. This may be accomplished using multi-stage compressors and multi-speed blowers to accommodate the peak loads and remain efficient at other lesser loads. Upon selection, a further environmental factor must be considered, namely de-rating of the HVAC unit in view of atmospheric pressure. As is well understood, because of differences in density of air at various altitudes, more volume of air will be required to convey a given amount of energy. For example, at sea level approximately 1,200 cubic feet per minute (cfm) of air can carry 36,000 British Thermal Units (BTU) whereas at 5,000 feet of elevation about 14,300 cfm are required to carry that same number of BTUs. This is commonly referred to as de-rating of the HVAC unit. The selected HVAC system 104 must be validated by comparing the de-rated cfm and cooling capacity for the requirements determined previously, and if insufficient, a different HVAC system should be selected. Once the cfm value and cooling capacity of the HVAC system are validated, the cfm value is used to design a duct system in the SSEP 100 to properly carry the air throughout the SESEP 100 to ensure proper levels of cooling.

By following the above-identified steps a thermal management system can be devised which takes into account both the needs of the SESEP 100 initially and also accounts for the system degradation over time as battery states of health and the efficiency of the HVAC system 104 declines to ensure that the performance of the SESEP 100 remains within acceptable tolerances.

Although embodiments have been described in detail with reference to the accompanying drawings for the purpose of illustration and description, it is to be understood that the inventive processes and apparatus are not to be construed as limited thereby. It will be apparent to those of ordinary skill in the art that various modifications to the foregoing embodiments may be made without departing from the scope of the disclosure as set forth in the following claims.

We claim:

1. A direct current aggregator comprising:
a plurality of battery strings having a positive terminal and a negative terminal;
a positive bus connected to a positive terminal of each of a plurality of battery strings;
a negative bus connected to a negative terminal of each of a plurality battery strings;
a switch associated with each positive terminal and each negative terminal of each of a plurality of battery strings, each switch capable of moving from a first open position to a second closed position;
a fuse associated with each positive terminal and each negative terminal of each of a plurality of battery strings; and
a controller in communication with each switch and operable to cause each switch to move from the first to the second position to selectively place or remove one or more of the plurality of battery strings in electrical communication with the positive bus and the negative bus.

2. The direct current aggregator of claim 1, further comprising a current transformer in electrical communication with the negative bus and in electrical communication with the switch associated with the negative terminal of each battery string.

3. The direct current aggregator of claim 2, wherein the current transformer outputs a signal representative of the current flowing from the battery string to an input/output (IO) module.

4. The direct current aggregator of claim 3, wherein the IO module receives an analog signal and outputs a digital signal to the controller.

5. The direct current aggregator of claim 1, wherein the batteries are installed in racks.

6. The direct current aggregator of claim 1, further comprising a voltage transformer sensing the voltage across the positive and negative busses.

7. The direct current aggregator of claim 6, wherein the voltage transformer outputs a signal representative of the voltage across the positive and negative busses to an input/output (IO) module.

8. The direct current aggregator of claim 7, wherein the IO module receives an analog signal and outputs a digital signal to the controller.

9. An energy storage platform comprising:
a container;
a plurality of racks formed within the container and sized to receive a plurality of batteries and form a plurality of battery strings;
a direct current aggregator including,
a plurality of first fuses connectable to at least one of the batteries strings;
a plurality of second fuses connectable to at least one of the batteries strings;
a set of first switches associated with each of the plurality of first fuses and capable of moving from a first open position to a second closed position;
a set of second switches associated with each of the plurality of second fuses and capable of moving from a first open position to a second closed position;
a positive bus electrically connected to each first switch;
a negative bus electrically connected to each second switch; and
a controller in communication with each first and second switch and operable to cause each first and second switch to move from the first position to the second position to selectively place or remove one or more of the plurality of battery strings in electrical communication with the positive bus and the negative bus.

10. The energy storage platform of claim 9, further comprising a plurality of batteries inserted into each of the plurality of racks and forming a plurality of battery strings.

11. The energy storage platform of claim 10, wherein each battery string is electrically connected to at least one first fuse and at least one second fuse.

12. The energy storage platform of claim 11, wherein each battery string is electrically connected to at least one first switch and at least one second switch.

13. The energy storage platform of claim 12, wherein each battery string is isolated from the positive and negative busses by moving the at least one first switch and the at least one second switch electrically connected thereto from the second position to the first position.

14. The energy storage platform of claim 9, further comprising at least one inverter.

15. The energy storage platform of claim 9, further comprising at least one internet connection for transmitting and receiving data from an energy management system.

16. The energy storage platform of claim 9, wherein the controller receives data from one or more of a remote temperature detector, airflow sensors, door sensors, voltage sensors, current sensors, power meters, fire suppression systems, or heating ventilation and air conditioning systems.
